(19) United States
(12) Patent Application Publication
(10) Pub. No.: US 2006/0087122 A1
(43) Pub. Date: Apr. 27, 2006

(54) Electric surplus power generator

(76) Inventor: Kent Saunders Sheffield, Richmond, VA (US)

Correspondence Address: Kent Saunders Sheffield, 706 Glenhaven Ct., Richmond, VA, 23236, US

(21) Appl. No.: 10/972,889

(22) Filed: Oct. 25, 2004

(51) Int. Cl. H02K 7/18; F03G 7/08; F02B 63/04

(52) U.S. Cl. 290/1 R

(57) ABSTRACT

The Enviromentally Clean Rechargable Power Supply is a small portable totally electric rechargable source of both 12 volt DC 15 amp electricity and up to 700 watts and 6.5 amps of 110 volt AC electricity. Invention can be recharged with a conventional battery charger. Invention is enviromentally clean and can be operated indoors or outdoors. Uses include but but are not limited to emergency power to light homes and apartments, back up power to operate computers in homes and offices, power for lighting boats and RVs, power to operate trolling motors, charge automotive and marine batteries and provide a source of electricity for camp lighting, radios etc. Larger models can provide power to operate small scooters, go karts etc. with electric drive motors.

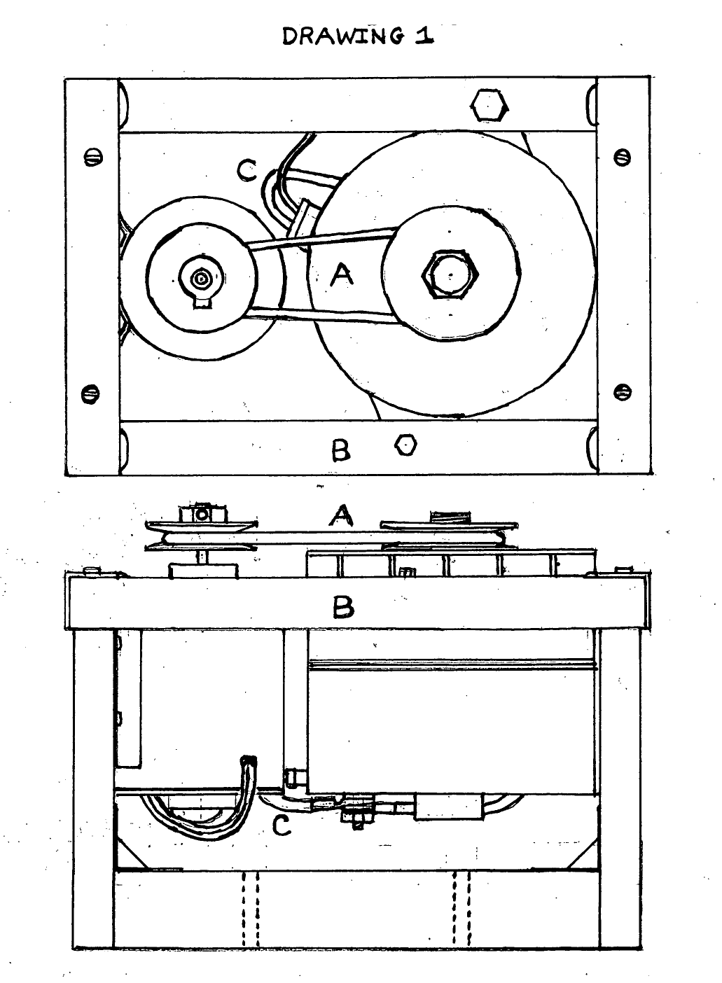

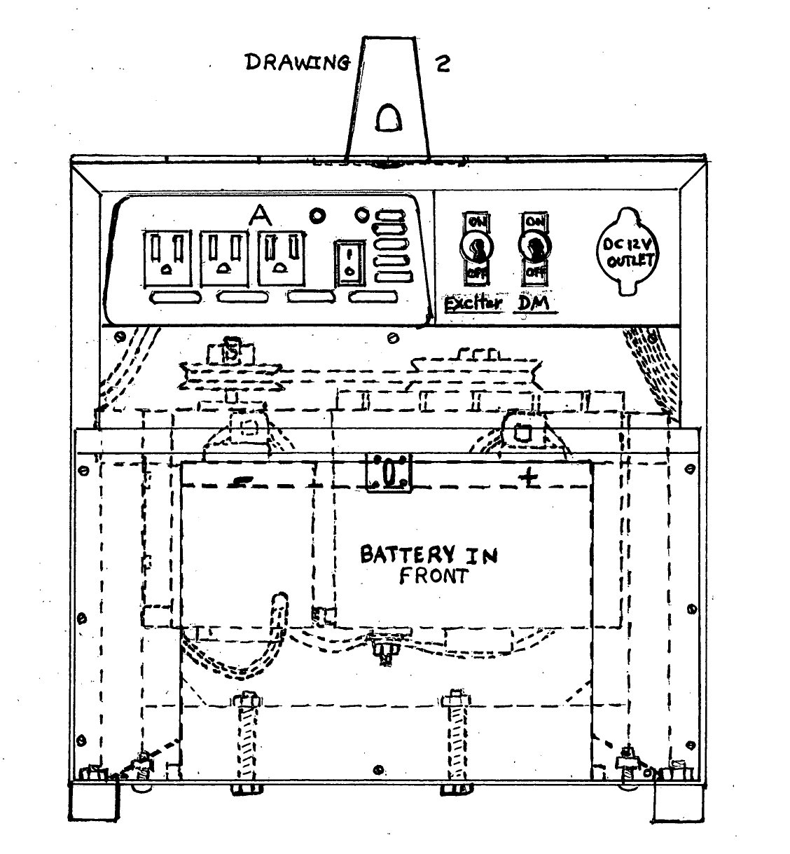

### BACKGROUND OF THE INVENTION

Prior to my invention small portable electric generators relied on a fuel source such as gasoline to power an internal combustion engine that drives the generator. These engines are generally noisy and exhaust gases pollute the air. These generators can not be safely operated indoors without venting exhaust gases to the outside. The possibility of carbon monoxide poison ing is always present. Those generators without battery and starter require physical exertion to start engine.

Power supplies relying solely upon batteries gennerally need more than one battery to extend intervals between recharging. Because of this need for multiple batteries these power supplies can become heavy and not as portable. All of the above mentioned problems or drawbacks are solved or inproved upon with the invention of my Enviromentally Clean Rechargable Power Supply.

The Enviromentally Clean Rechargable Power Supply utilizes one battery to start a fractional horsepower drive motor that turns an alternator. Multiple batteries are not necessary. Alternator runs drive motor and charges battery. The Enviromentally Clean Rechargable Power Supply is enviromentally friendly. Being totally electric there is no air pollution and minimal noise pollution. My invention can be safely operated indoors or outdoors. Recharging of battery from an outside source is necessary from time to time but easily accomplished using conventional automotive battery charger.

### BRIEF SUMMARY OF THE INVENTION

The Enviromentally Clean Rechargable Power Supply is a small, portable, totally electric supplier of 12 volt DC and 110 volt AC electricity. Stored electricity from an automotive battery starts a small fractional horsepower 12 volt DC electric drive motor that turns an automotive alternator. The alternator produces 12 volt DC electricity to power the drive motor and charge the battery. Battery must be recharged from an outside source when battery voltage drops below that necessary to maintain drive motor at operating rpms. A power inverter provides the 110 volt AC electricity. Recharging is accomplished through use of a convention al battery charger (automotive). Invention requires no flamible fuel to operate, does not pollute the air, cost to operate is minimal, with little physical effort to start other than flipping three small switches and is rechargable. Battery can be recycled.

### DETAILED DESCRIPTION OF THE INVENTION

The Enviromentally Clean Rechargable Power Supply or ECRPS is a small portable totally electric rechargable from outside source 12 volt DC and 110 volt AC power supply. A 12 volt DC automotive wet cell battery or a 12 volt DC lawn tractor battery starts a small 3,000 rpm 5 amp fractional hp 12 volt DC permanent magnet drive motor. Horsepower is approximately one tenth hp. This motor belt drives an early model 78 amp Delco automotive alternator with internal voltage regulator. Alternator runs drive motor and charges battery. A 700 watt 6.5 amp 110 volt AC Vector model VEC 062 power inverter is wired to battery and uses reserve stored power from battery to operate. All components are negative ground. The drive motor is fitted with a two and one half inch dia. by one half inch bore alloy pulley. The bore of pulley is reduced using a bronze bushing to five sixteenths inches dia. to fit drive motor shaft. The alternator pulley is a standard Delco two and five eights inch dia. pulley. Both pulleys are A width V belt pulleys. A standard Delco cooling fan cog is used to cool alternator and drive motor. A Prym Dritz brand round black rubber replacement sewing machine belt is used to turn alternator. This belt is elastic and can be stretched over pulleys. The approximate operating rpms of alternator is 2,800 rpms producing approximately 20 amps DC electricity at 12 volts. A 3 L V belt can be substituted for sewing machine belt with a slight drop in alternator rpms. 3 L V belt should be installed with just enough tension so belt doesn't slip on pulleys. All casting lines and burrs should be removed from inside of pulleys.

The drive motor and alternator are grounded to the angle iron frame that supports the alternator. The alternator is mounted to the bottom surfaces of two parallel one inch by one inch by one eighth inch thick angle iron rails with one three eighth inch dia. by three inch long hex bolt on one rail and one quarter inch dia. by one and one half inch long hex bolt on opposite rail length. The angle iron rails are part of a rectangular welded frame that supports alternator. The original bolt mounting holes of alternator are used. A wooden base supports the angle iron frame. The drive motor is secured to the inside wall of one end of the wooden frame with wood screws. The wooden base is composed of a nine and one eighth long piece of 2 by 8 inch pine board with finnished size of one and one half inch thick by seven and one quarter inches wide. Two three quarter inch thick by seven and one quarter inch wide and seven inches tall pine boards are secured to the ends of the base with three wood screws each and a small Simpson brand metal framing right angle support at each inside right angle of wooden frame. A one eighth inch thick by seven and one quarter inch long by three quarter inch wide aluminum channel caps each end support of the wooden frame. They are secured with two flush mounted wood screws each. The wooden frame serves as a jij for welding the angle iron frame. Two ten and three quarter inch long pieces of angle iron are placed with bottom flat surface resting on ends of aluminum channels. Then seven and one half inch widths of angle iron are placed over the lengths at each end and welded in place. The angle iron rack is secured to the aluminum channels with four sheet metal screws, one screw at each corner. See Drawing 1, FIG. B.

The electric drive motor is wired directly to the battery, positive wire to positive battery terminal and negative wire to negative battery terminal. An inline 15 amp fuse placed between battery and drive motor of positive wire protects drive motor. The alternator is wired as follows. A two wire, one white and one red Delco or after market ignition voltage regulator plug is snap ped into place on lower side of alternator housing. The white positive wire is connected to an ON OFF toggle switch with wire from switch going to positive battery terminal. This wire sends current to excite alternator so that electricity can be produced in the alternator. The red wire is also positive and is connected to the positive output terminal of alternator. A second red positive wire is connected to the output terminal of the alternator and carries current back to the battery. This wire is also connected to the positive terminal of battery. Diodes already inside the alternator keep the current flowing in the right direction. See Drawing 1, FIG. C.

The internal voltage regulator must be capable of maintaining the battery at 11.5 volts to operate the Vector power invertor. Some power inverters will work as low as 10.5 volts. The Delco or after market internal voltage regulator used should not drop below 11.5 volts before charging the battery. The higher the cut in the better to sustain drive motor rpms and alternator output. Vector power inverter is wired directly to the battery, red positive wire to positive battery terminal and black negative wire to negative battery terminal. Power inverter is mounted above the battery, alternator and drive motor on a 22 gauge galvanized sheet metal shelf. See Drawing 2, FIG. A.

The cabinet of the Enviromentally Clean Rechargable Power Supply is constructed of 22 gauge galvanized sheet metal. Cabinet size is fifteen and one quarter inches long by eleven and seven eighth inches wide and tall. Four hard rubber viberation dampening feet are bolted to bottom of cabinet. A hinged 22 gauge control panel cover made of galvanized sheet metal with rolled bottom edge is mounted using piano hinges Control panel cover is lockable. Inside control panel from left to right is the power inverter, alternator exciter switch that operates independently of the drive motor switch, the drive motor switch and finally in far right hand position the 15 amp fused 12 volt DC power outlet. Three 110 volt AC outlets are found on the far left side of the control panel, being a part of power inverter. The power inverter ON OFF rocker switch and LED green power light and LED red low or high voltage light are found to the right of the 110 volt AC outlets. A sturdy non conductive carrying handle is mounted on the top center of metal cabinet. Extra metal reinforcing is placed underneath top of cabinet for added strength to support handle. A wiring conforms to automotive industry standards. Vector 110 volt AC outlets conform to North American UL standards.

To operate the Enviromentally Clean Rechargable Power Supply, place unit on a level spot and inspect for moisture inside the cabinet by unlocking control panel cover and look for condensation inside the cabinet. If wet inside cabinet do not operate. Dry before using. Now decide if you want to use the 12 volt DC outlet or the 110 volt AC outlets. If you decide to use the 12 volt DC outlet located to the far right side of control panel first determine if the device you intend to use does not exceed 15 amps and the standard plug and cord is in good condition. If it is in good condition and does not exceed 15 amps, using thumb placed at bottom tab of outlet cover lift cover up and at the same time insert device plug into outlet until it fits snugly at end of outlet. Always keep device turned OFF when you plug into outlet or remove plug from outlet. Next move the EXCITER switch found to the right of power inverter to the ON position. Now move the DRIVE MOTOR (DM) switch to the ON position. You are now ready to use 12 volt DC device. To avoid frequent recharging practice conservation of stored battery electricity by using either one 12 volt DC device at a time without using power inverter. This conservation measure also applies to use of power inverter. To unplug 12 volt DC device make sure device is turned OFF. Next turn EXCITER switch to the OFF position. Then turn DRIVE MOTOR (DM) switch to the OFF position. Now remove 12 volt DC plug and snap protective cover over outlet. CAUTION, battery power to outlet is still flowing to outlet. Do not stick fingers or objects into outlet other than servicable 12 volt DC plug.

To operate power inverter follow all safety precautions listed for using 12 volt outlet electricity. Now turn EXCITER switch to the ON position. Next turn DRIVE MOTOR (DM) switch to the ON position. Wait about five seconds for drive motor to reach operating speed. Drive motor switch is just to right of exciter switch. Now press to the ON position the small rocker switch of power inverter found to the right of power inverter outlets. Wait for the small red LED light to go off and the small green LED light to come on. Both lights are found above ON,OFF rocker power inverter switch. Make sure to match capabilities of power inverter with device being used. With electrical device turned off plug 110 volt AC device into one of three outlets. Make sure device plug and power cord are in good condition. Plug should be a grounded three prong type. If you are uncertain of power requirements of electrical device you intend to use read electrical input data usually found on most devices. If this can not be obtained, consult with manufacturer for specifications before attempting to use in power inverter. It is important to match power requirements of electrical device to power inverter. Should small red light come on while operating a device, turn OFF power inverter rocker switch and unplug electricial device from power inverter outlet. You are at or above the power capabilities of power inverter. Should an alarm sound while operating an electrical device the power inverter is probably receiving low volt age from the battery. Again, turn power inverter power switch to the OFF position and unplug electrical device. Follow power inverter makers instructions. Normally a low voltage battery prob lem can be corrected by letting the alternator charge the battery with no power being used. It may be necessary to charge battery with an automotive battery charger from an outside source if the alternator drive motor is unable to reach normal operating rpm range. Most conventional or deep cycle automotive or marine battery chargers in the 10 amp 12 volt DC output range will work. Consult battery charger maker for specific charging instructions.

To shut down Enviromentally Clean Rechargable Power Supply power inverter turn off any devices plugged into power inverter outlets. Turn OFF power inverter power switch. Unplug all devices from power inverter. Turn OFF EXCITER switch and then DRIVE MOTOR (DM) switch. If there is an electrical device plugged into 12 volt DC outlet remove device plug at this time. Close and lock control panel cover for safety and store power supply in a secure dry location. This means away from small children or todlers. It is very important that the control console panel cover be locked. Electrical equipment of this type should never be used where children could come in contact with open (hot) outlets. For this reason all production units will have a separate ON,OFF 12 volt DC outlet switch in addition to protective outlet cover.

What I claim as my invention is the enviromentally clean rechargable power supply.

1. Invention is a portable, totally electric, rechargable from an outside source, supplier of both 12 volt DC and 110 volt AC electricity whereby stored electricity from a storage battery provides electricity to a fractional horsepower drive motor that turns an alternator capable of running fractional horsepower drive motor and charging storage battery and the storage battery supplies stored electricity to a 12 volt DC outlet and stored electricity to a power inverter producing 110 volt AC electricity.
